(19) United States
(12) Patent Application Publication
(10) Pub. No.: US 2015/0218679 A1
(43) Pub. Date: Aug. 6, 2015

(54) ALUMINUM ALLOY AUTOMOBILE PART

(71) Applicant: Kabushiki Kaisha Kobe Seiko Sho (Kobe Steel, Ltd.), Kobe-shi Hyogo (JP)

(72) Inventors: Yasuhiro Aruga, Kobe-shi (JP); Hisao Shishido, Kobe-shi (JP)

(73) Assignee: Kabushiki Kaisha Kobe Seiko Sho (Kobe Steel, Ltd.), Kobe-shi Hyogo (JP)

(21) Appl. No.: 14/425,405

(22) PCT Filed: Sep. 13, 2013
(86) PCT No.: PCT/JP2013/074862

§ 371 Date: Mar. 3, 2015

(30) Foreign Application Priority Data
Sep. 20, 2012 (JP) 2012-207188
Sep. 20, 2012 (JP) 2012-207189

(51) Int. Cl. C22C 21/10; C22F 1/053; B62D 29/00

(52) U.S. Cl. CPC C22C 21/10; B62D 29/008; C22F 1/053

(57) ABSTRACT

Provided is an automobile part comprising a 7000-series aluminum alloy sheet and provided with both strength and stress corrosion cracking resistance. The automobile part is configured from a 7000-series aluminum alloy sheet having a specific composition, and after artificial aging processing, the grain size distribution of precipitates evaluated by means of a small angle x-ray scattering among the crystal grains of the aluminum alloy plate and the normalized dispersion of the grain size distribution are controlled, resulting in being simultaneously provided with high strength in the form of an 0.2% proof stress of at least 350 MPa, high ductility, and SCC resistance. Also, the automobile part is configured from a 7000-series aluminum alloy sheet having a specific composition, and after artificial aging processing, a specific number density of nanosized precipitates are caused to be present as measured by a transmission electron microscope at 300,000× magnification in the crystal grains of the aluminum alloy plate, resulting in being simultaneously provided with high strength in the form of an 0.2% proof stress of at least 350 MPa, high ductility, and SCC resistance.

### TECHNICAL FIELD

The present invention relates to a high-strength aluminum alloy automobile part.

### BACKGROUND ART

In recent years, from the concerns for the global environment, the social demand for the reduction in the weights of automobile bodies has been increased. In order to respond to such demand, some of automobile body components, such as panels (hoods, doors, roofs and other outer panels and inner panels), bumper reinforcements (bumper R/F), door beams and other reinforcements, aluminum alloy materials have been applied partially in place of iron steel materials such as steel plates.

However, in order to achieve the weight reduction of an automobile body, among automobile parts, the application of aluminum alloy materials need to be extended to automobile structural components such as the frames, pillars which contribute especially to weight reduction. However, these automobile structural components require the 0.2% proof stress of 350 MPa or higher and other conditions, and therefore need to have higher strength than the automobile panels. In this point, JIS and AA 6000 series aluminum alloy plate having excellent formability, strength, corrosion resistance, low alloy content and high recyclability used for the above-mentioned automobile panels are highly limited in achieving the above-mentioned higher strength even if their composition and thermal refining (solutionizing process and quenching, further artificial age hardening treatment) are controlled.

Therefore, JIS or AA 7000 series aluminum alloy plates used as the reinforcement for which equally high strength is required need to be used for such high-strength automobile structural components. However, the 7000 series aluminum alloy, which is an Al—Zn—Mg alloy, is an alloy which achieves high strength by causing precipitates MgZn₂ composed of Zn and Mg to distribute at a high density. Hence, it may cause stress corrosion crack (hereinafter referred to as SCC). In order to prevent this, as the actual situation, overage treatment has been inevitably performed on the 7000 series aluminum alloys and they are used at a proof stress of about 300 MPa. This has been sacrificing their features as the high-strength alloys.

Accordingly, various methods of controlling the composition of 7000 series aluminum alloy having both excellent strength and SCC resistance and controlling microstructures of precipitates and the like have been conventionally proposed.

Typical examples of the methods of controlling the composition include patent literature 1 in which, by utilizing the ability of Mg added in an amount excessively higher than the amount (MgZn₂ stoichiometric ratio) of Zn and Mg which form MgZn₂ in just quantities to contribute to increasing the strength of 7000 series aluminum alloy extruded material, Mg is added in an amount excessively higher than stoichiometric ratio of MgZn₂ to suppress the amount of MgZn₂, whereby higher strength is achieved without lowering the SCC resistance.

Typical examples of controlling the microstructures such as precipitates include patent literature 2, in which precipitates having a grain size in crystal grains of the 7000 series aluminum alloy extruded material after the artificial age hardening treatment of 1 to 15 nm are caused to exist at a density of 1000 to 10000 counts/μm² in the observation results by a transmission electron microscope (TEM), so that the potential difference between grain insides and grain boundaries is reduced and the SCC resistance is improved.

In addition, although all examples cannot be indicated, many examples of controlling the composition, controlling the microstructure of precipitates and the like exist proportionately to the large number of the practices using extruded materials. In contrast, the number of known examples of controlling composition and controlling microstructures of precipitates in a 7000 series aluminum alloy plate are extremely small proportionately to the small number of practices using plates.

For example, patent literature 3 suggests that in a structural material composed of a clad plate in which two 7000 series aluminum alloy plates are weld-bonded together, in order to improve the strength, the aged precipitates after the artificial age hardening treatment are caused to exist as spheres with a diameter of 50 Å(angstrom) or lower in a certain amount. However, the document has no disclosure about the SCC resistance performance, and shows no data about corrosion resistance in its Examples.

In addition, patent literature 4 describes that in the measurement under an optical microscope of 400 magnification, crystal precipitates in crystal grains of the 7000 series aluminum alloy plate after the artificial age hardening treatment are caused to have the size (calculated as the diameter of a circle having an equivalent area) of 3.0 μm or lower, and an average area fraction of 4.5% or lower to improve the strength and elongation. However, the document has no disclosure about the SCC resistance performance, and no data about corrosion resistance is shown in its Examples.

### CITATION LIST

### Patent Literature

Patent literature 1: Japanese Unexamined Patent Publication No. 2011-144396

Patent literature 2: Japanese Unexamined Patent Publication No. 2010-275611

Patent literature 3: Japanese Unexamined Patent Publication No. H9-125184 Patent literature 4: Japanese Unexamined Patent Publication No. 2009-144190

### SUMMARY OF INVENTION

### Technical Problem

As mentioned above, suggestions for controlling the composition of a 7000 series aluminum alloy having both excellent strength and SCC resistance and controlling the microstructures of precipitates and the like have been conventionally made with regard to extruded materials. However, 7000 series aluminum alloy sheets in the form of hot-rolled plates or cold-rolled plates (plates produced by further cold-rolling a hot-rolled plate) have not been often suggested except for the purpose of improving the strength as a matter of fact.

Extruded materials are completely different from sheets in their production steps such as hot working steps. The extruded materials have such microstructures that the crystal grains and precipitates formed are, for example, in the form of fibers in which crystal grains are elongated in the direction of extrusion, which are greatly different from those of sheets, in which crystal grains are basically equiaxed grains. Accordingly, it is unknown if the suggestions of controlling the composition and controlling microstructure such as precipitates in the extruded materials could be directly applied to 7000 series aluminum alloy sheets and to automobile parts made of such 7000 series aluminum alloy sheets to effectively improve both strength and SCC resistance. That is, it stays nothing more than anticipation unless it is actually confirmed

Therefore, an effective technique for controlling the microstructure of an automobile part made of a 7000 series aluminum alloy sheet which is excellent in both strength and SCC resistance has not yet been implemented, and remains uncertain and to be proved.

In view of the above-mentioned problems, an object of the present invention is to provide an automobile part made of a 7000 series aluminum alloy sheet which is excellent in both strength and stress corrosion crack resistance.

### Solution to Problem

In order to achieve this object, as a purpose of the present invention, the aluminum alloy automobile part of the present invention includes an Al—Zn—Mg alloy sheet having the composition: containing, by mass %, Zn: 3.0 to 8.0%, and Mg: 0.5 to 4.0%, with the remainder consisting of Al and inevitable impurities, the aluminum alloy sheet having, after the artificial age hardening treatment, an average grain diameter of the precipitates measured by the small angle X-ray scattering of 1 nm or more but 7 nm or less, having a microstructure in which the normalized dispersion of the precipitate size distribution is 40% or lower, and having a 0.2% proof stress of 350 MPa or higher.

In addition, in order to achieve this object, as a purpose of the present invention, the aluminum alloy automobile part includes an Al—Zn—Mg alloy sheet having the composition: containing, by mass %, Zn: 3.0 to 8.0%, and Mg: 0.5 to 4.0%, with the remainder consisting of Al and inevitable impurities, the aluminum alloy sheet having, after the artificial age hardening treatment, a number density of precipitates with a diameter of 2.0 to 20 nm in the measurement under a transmission electron microscope of 300000 magnifications of 2.0×10⁴ counts/μm³ or higher in average, and having a 0.2% proof stress of 350 MPa or higher.

### Advantageous Effects of Invention

The aluminum alloy sheet referred to in the present invention is a material aluminum alloy plate such as a hot-rolled plate produced by hot-rolling and a cold-rolled plate produced by cold-rolling, which is further treated by solutionizing process, quenching and other thermal refining. Moreover, the present invention is an automobile part which has been processed into such a material aluminum alloy sheet into an automobile part, further incorporated as an automobile part, and subjected to an artificial age hardening treatment.

Therefore, in the present invention, not the state of the aluminum alloy sheet of the material, but the composition, microstructure and strength as an automobile part, which is the final use state, are defined. That is, the composition, microstructure, and strength after the material aluminum alloy sheet has been assembled as an automobile part, and further subjected to artificial age hardening treatment as an automobile body are defined. The artificial age hardening treatment referred to in the present invention means the age hardening process by artificial heating, and is clearly distinguished from natural age hardening at room temperature and the like (hereinafter referred to simply as artificial aging treatment or aging treatment).

In the present invention, the grain size distribution of precipitates within crystal grains measured by the small angle X-ray scattering of such an aluminum alloy automobile part is controlled. In addition, precipitation of precipitates existing intergranularly and coarse precipitates existing within crystal grains can also be suppressed by this control.

In addition, in the present invention, nano-sized minute precipitates which can be measured by a high-powered transmission electron microscope of such an aluminum alloy automobile part are caused to exist at the above-mentioned defined number density within crystal grains. In addition, precipitation of precipitates existing intergranularly and coarse precipitates existing within crystal grains by this control can also be suppressed.

By this configuration, the present invention can achieve such high strength such that the 0.2% proof stress of the aluminum alloy automobile part is 350 MPa or higher, and can suppress a reduction in the SCC resistance in spite of such high strength.

### DESCRIPTION OF EMBODIMENTS

Embodiments of the present invention will be specifically described for each requirement.

First, the chemical components as the automobile part of the present invention or of the material aluminum alloy sheet will be described below including limiting reasons of each element. It should be noted that the amounts of the elements contained indicated by % are all by mass %.

The chemical components of the aluminum alloy sheet of the present invention are determined to assure the characteristics such as the strength and SCC resistance of automobile parts intended in the present invention as the Al—Zn—Mg—Cu-based 7000 series aluminum alloy. From this perspective, the chemical components of the aluminum alloy sheet of the present invention includes, by mass %, Zn: 3.0 to 8.0%, and Mg: 0.5 to 4.0%, with the remainder consisting of Al and inevitable impurities. This composition may further include one or two elements from Cu: 0.05 to 0.6% and Ag: 0.01 to 0.15% selectively, and in addition, separately, may include one or more elements from Mn: 0.05 to 0.3%, Cr: 0.03 to 0.2%, and Zr: 0.03 to 0.3% selectively.

Zn: 3.0 to 8.0%:

An essential alloy element Zn, as well as Mg, forms fine precipitates to improve strength and elongation during the artificial age hardening treatment, which are intermetallic compounds of Mg and Zn defined by the present invention. When the amount of Zn contained is lower than 3.0%, the strength becomes insufficient, while when the amount is higher than 8.0%, the precipitates MgZn₂ at grain boundaries are increased to increase the SCC sensitivity. Therefore, the amount of Zn contained is to be in the range from 3.0 to 8.0%. In order to suppress an increase in this amount of Zn contained and the SCC sensitivity, it is desirable to add Cu or Ag described later. It is preferably to be 4.0 to 7.0%.

Mg: 0.5 to 4.0%

An essential alloy element Mg, as well as Zn, forms fine precipitates (MgZn clusters) which are intermetallic compounds of Mg and Zn defined by the present invention during the artificial age hardening treatment, to improve strength and elongation. When the amount of Mg contained is lower than 0.5%, strength becomes insufficient, while when it is higher than 4.0%, the rolling property of the plate is lowered, and the SCC sensitivity is increased. Therefore, the amount of Mg contained is to be in the range from 0.5 to 4.0%, and preferably 3.0% or lower.

One or two elements from Cu: 0.05 to 0.6%, and Ag: 0.01 to 0.15%:

Cu and Ag act to improve the SCC resistance of the Al—Zn—Mg-based alloy. When either or both of these are contained, if the amount of Cu contained is lower than 0.05%, and the amount of Ag contained is lower than 0.01%, little effects in improving the SCC resistance are produced. In contrast, when the amount of Cu contained is higher than 0.6%, various characteristics such as the rolling property and weldability are lowered on the contrary. When the amount of Ag contained is higher than 0.15%, the effects of Ag are saturated, resulting in increased costs. Therefore, the amount of Cu contained is to be 0.05 to 0.6%, preferably 0.4% or lower, and the amount of Ag contained is to be 0.01 to 0.15%.

One or more elements of Mn: 0.05 to 0.3%, Cr: 0.03 to 0.2%, and Zr: 0.03 to 0.3%:

Mn, Cr and Zr contribute to increasing the strength by micronizing crystal grains of the ingot.

When any one, two or three elements of these are contained, if the amounts of Mn, Cr, and Zr contained are all below the lower limits, the amounts contained become insufficient, and recrystallization is promoted, so that the SCC resistance lowers. In contrast, when the amounts of Mn, Cr, and Zr contained are higher than their upper limits, respectively, coarse precipitates are formed and therefore elongation is lowered. Therefore, the ranges of the elements contained are to be as follows: Mn: 0.05 to 0.3%, Cr: 0.03 to 0.2%, and Zr: 0.03 to 0.3%.

Ti, B:

Ti and B are impurities in a rolled plate, but are effective in micronizing crystal grains of the aluminum alloy ingot. Therefore, they are allowed to be contained within the ranges defined by the JIS standard as the 7000 series alloy, respectively. The upper limit of Ti is to be 0.2%, preferably 0.1%, the upper limit of B is to be 0.05% or lower, and preferably 0.03%.

Other Elements:

In addition, other elements such as Fe and Si than those described above are inevitable impurities. Therefore they are allowed to be contained within the ranges defined by the JIS standard of the 7000 series alloy, respectively, as melting materials, in addition to pure aluminum base metal, anticipating (allowing) the inclusion of these impurity elements due to the use of aluminum alloy scrap. For example, when Fe: 0.5% or lower, and Si: 0.5% or lower, the characteristics of the rolled plate according to the present invention aluminum alloy are not affected, and such inclusion is therefore allowed.

(Microstructure)

In the present invention, the 7000 series aluminum alloy microstructure of the automobile part is defined as such a microstructure, as the crystal grain (within crystal grains) microstructure after being subjected to the artificial age hardening treatment, that the average grain diameter of the precipitates measured by the small angle X-ray scattering is 1 nm or more but 7 nm or less and the normalized dispersion of the grain size distribution is 40% or lower.

These precipitates are the above-mentioned intermetallic compounds (composition: MgZn₂, etc.) of Mg and Zn produced in crystal grains during the artificial age hardening treatment and other steps, and are fine dispersion phases further containing inclusion elements such as Cu and Zr depending on the composition. It should be noted that the diameter of precipitates in the present invention refers to a diameter of a circle corresponding to amorphous precipitates.

As mentioned above, by controlling the average grain diameter of the grain size distribution of precipitates measured by the small angle X-ray scattering and the normalized dispersion indicating the extent of the grain size distribution, such increases in strength and elongation that the 0.2% proof stress of the aluminum alloy automobile part is 350 MPa or higher can be achieved. Simultaneously, the precipitation of precipitates existing intergranularly and coarse precipitates existing in crystal grains can also be suppressed, which also contributes to the improvement in strength and elongation. Moreover, in spite of such high strength, it also leads to the suppression of lowered SCC resistance.

When the average grain diameter of this grain size distribution of precipitates is lower than 1 nm, or is higher than 7 nm on the contrary, or the normalized dispersion of the grain size distribution is higher than 40%, the higher strength cannot be achieved. The reason for this is that the precipitates which contribute to the improvement of strength becomes insufficient, and that it is very likely that production of precipitates existing intergranularly and coarse precipitates existing in crystal grains are increased during the above-mentioned artificial aging treatment. As a result, the SCC resistance is also lowered. However, the normalized dispersion of the above-mentioned grain size distribution has a manufacturing limit depending on the control of the composition and heat treatment, and can be only reduced by about 5% as the lower limit.

In the present invention, not this material aluminum alloy sheet but this rolled plate is processed, and the microstructure of the rolled plate as an automobile part after being further subjected to the artificial age hardening treatment is defined as the microstructure. The nano-sized fine precipitates defined in the present invention vary greatly depending on the heat treatment conditions, and greatly vary after solutionizing and quenching of the material aluminum alloy sheet, and depending on the following painting and baking processes of the automobile body and the artificial aging treatment conditions.

Precipitates in which the grain diameter of the present invention is 1 nm or more but 7 nm or less, or the average grain diameter of grain size distribution, and the normalized dispersion of grain size distribution, cannot be observed or measured under optical microscopes of about 400 magnifications used in the above-mentioned prior art techniques since they are extremely fine, but can be evaluated by the defined small angle X-ray scattering.

Small-Angle Scattering Technique Using X-Ray:

The small-angle scattering technique using X-ray itself has been long known as a typical technique for investigating structural information in the order of nanometers. When an object is irradiated with X-ray, the incident X-ray reflects the information of the electronic density distribution inside the object, and the scattered X-ray is generated around the incident X-ray. For example, if there is any region in which grains and electronic densities are inhomogeneous exists in the object, whether they are crystalline or amorphous, the X-ray interferes to generate scattering which results from density fluctuations. If this is a metal such as aluminum alloy, when precipitates in the order of nanometers exist in the aluminum alloy microstructure, scattering originating from the grains is observed. As the region in which this scattered X-ray is generated in the case of the X-ray with a wavelength of 1.54 Å using a Cu target, the measurement angle 20 is about 0.1 to 10 degrees or less. Employing the small angle X-ray scattering allows obtaining the forms, sizes, and distribution of the fine grains in the order of nanometers, among other information.

For example, in Japanese Unexamined Patent Publication No. 2011-38136 and other documents, this technique is used to measure the average grain diameter of grain size distribution of precipitates in relation with the generation of stretcher strain mark during press forming of 5000 series Al—Mg-based aluminum alloy plate, and the number density of the peak size of this precipitate size distribution.

In order to measure the average grain diameter of the grain size distribution of precipitates of the aluminum alloy microstructure and the number density of the peak size of this precipitate size distribution, first, the scattering intensity profile of the X-ray of the aluminum alloy plate measured by the small angle X-ray scattering is determined. The intensity profile of the X-ray scattering is determined, for example, as the vertical axis being the scattering intensity of X-ray (scattering intensity of the scattered X-ray), and the horizontal axis being a wave number vector q (nm⁻¹) which is dependent on the measurement angle 20 and wavelength λ.

The average grain diameter of grain size distribution of precipitates of the present invention of 1 nm or more but 7 nm or less and the normalized dispersion indicating the width of this grain size distribution can be determined from the intensity profile of the X-ray scattering. That is, by fitting the scattering intensity of X-ray measured and the X-ray scattering intensity calculated from a theoretical equation indicated by the function of the grain diameter and size distribution by fitting by nonlinear least-squares method so that they are approximated, the grain diameter and the normalized dispersion value can be determined.

As the analysis method (analysis software) which determines the grain size distribution of minute precipitates by analyzing such an intensity profile of the X-ray scattering, a known analysis method by Schmidt et al. (refer to I. S. Fedorova and P. Schmidt: J. Appl. Cryst. 11, 405, 1978), for example, is used.

Measurement Apparatus of Small Angle X-Ray Scattering:

As such a measurement apparatus of the small angle X-ray scattering, for example, typical small angle scattering goniometers are disclosed in Japanese Unexamined Patent Publication No. H9-119906 and other documents, in which a sample is irradiated with X-ray at a minute angle (small angle), and the X-ray scattered from the sample is measured using a two-dimensional multi wire type detector or other device.

In the region in which this scattered X-ray generates in the case of the X-ray with a wavelength of 1.54 Å, the measurement angle is as small as about 0.1 to 10 degrees. By analyzing this scattered X-ray as mentioned above, the information such as the grain size distribution, shapes, size, and distribution of grains can be obtained.

(Microstructure)

In addition, in the present invention, the 7000 series aluminum alloy microstructure of the automobile part is defined to be, as the microstructure after being subjected to the artificial age hardening treatment, a microstructure in which the number density of precipitates with a diameter of 2.0 to 20 nm measured under a transmission electron microscope of 300000 magnifications is 2.0×10⁴ counts/μm³ in crystal grains in average. These precipitates are the above-mentioned intermetallic compounds (composition: MgZn₂, etc.) of Mg and Zn produced in crystal grains during the artificial age hardening treatment and other steps, and are fine dispersion phases further containing inclusion elements such as Cu and Zr depending on the composition. It should be noted that the diameter of precipitates in the present invention refers to a diameter (average diameter) of a circle corresponding to amorphous precipitates.

As mentioned above, by causing precipitates with minute diameter of 2.0 to 20 nm to exist at the above-mentioned defined certain number density in crystal grains, improvement in strength and elongation of the aluminum alloy automobile part in which 0.2% proof stress is 350 MPa or higher can be achieved. In addition, by causing precipitates of minute sizes to exist as defined above, the precipitation of precipitates existing intergranularly and coarse precipitates existing in crystal grains can also be suppressed, which also contributes to the improvement in strength and elongation. Moreover, in spite of such high strength, it also leads to the suppression of lowered SCC resistance.

When this number density of precipitates with a diameter of 2.0 to 20 nm is lower than 2.0×10⁴ counts/μm³ in crystal grains in average, the higher strength cannot be achieved. The reason for this is that the above-mentioned fine precipitates with a diameter of 2.0 to 20 nm which contributes to the improvement in strength become insufficient. The upper limit of the number density of these precipitates with a diameter of 2.0 to 20 nm is limited by the manufacturing limit due to the control of the composition and heat treatment, and the precipitates can only be precipitated in grains in the order of 10⁵ counts/μm³ in average as the upper limit.

In the present invention, not this material aluminum alloy sheet but this rolled plate is processed, and is defined as the microstructure as an automobile part after being further subjected to the artificial age hardening treatment. The nano-sized fine precipitates defined in the present invention vary greatly depending on the heat treatment conditions, and after solutionizing and quenching of the material aluminum alloy sheet, and greatly vary depending on the following the artificial aging treatment conditions.

The number density of precipitates with a diameter 2.0 to 20 nm of the present invention cannot be observed or measured under optical microscopes of about 400 magnifications used in the above-mentioned prior art techniques since they are extremely fine, but can be observed under a high-powered transmission electron microscope of 300000 magnifications defined.

(Production Method)

The method for producing the 7000 series aluminum alloy sheet in the present invention will be specifically described below.

In the present invention, the 7000 series aluminum alloy sheet can be produced by a production method according to normal manufacturing steps of the 7000 series aluminum alloy sheet. That is, the aluminum alloy sheet is produced through normal manufacturing steps including casting (DC casting process, continuous casting method), homogenizing heat treatment, and hot-rolling, formed into an aluminum alloy hot-rolled plate with a gauge of 1.5 to 5.0 mm. The aluminum alloy hot-rolled plate may be the final product plate at this stage, or may be further cold-rolled while being selectively subjected to one or more intermediate annealings before the cold rolling or during the cold rolling, to be formed into a final product cold-rolled plate with a gauge of 3 mm or less.

(Melting, Casting Cooling Rate)

First, in the melting, casting step, the aluminum alloy molten metal which has been melt and adjusted within the composition range of the above 7000 series composition is cast by a suitably selected normal melting casting method such as the continuous casting method, semi-continuous casting method (DC casting process).

(Homogenizing Heat Treatment)

Next, the cast aluminum alloy ingot is subjected to, prior to the hot-rolling, a homogenizing heat treatment. The aim of this homogenizing heat treatment (soaking) is to homogenize the microstructure, that is, to remove the segregation of crystal grains in the ingot microstructure. The homogenizing heat treatment conditions are suitably selected from the temperature range from about 400 to 550° C. and the homogenization time range of 2 hours or more.

(Hot-Rolling)

The hot-rolling itself becomes difficult under such conditions that the hot rolling starting temperature is higher than the solidus line temperature since burning occurs. In addition, when the hot rolling starting temperature is lower than 350° C., the load during the hot rolling becomes too high, and the hot rolling itself becomes difficult. Therefore, the hot rolling is performed at the hot rolling starting temperature selected from the range from 350° C. to the solidus line temperature, giving a hot-rolled plate with a gauge of about 2 to 7 mm. The annealing (rough annealing) of this hot-rolled plate before the cold rolling is not always necessary, but may be performed.

(Cold Rolling)

In the cold rolling, the above hot-rolled plate is rolled, producing a cold-rolled plate (including a coil) with a desired final gauge of about 1 to 3 mm. An intermediate annealing may be performed between the cold rolling passes.

(Solutionizing and Quenching)

After the cold rolling, solutionizing and quenching are performed. The solutionizing and quenching process may be a common heating and cooling method, and is not particularly limited. However, in order to obtain sufficient amounts of solid-solutionized elements and micronize crystal grains, it is desirable to set the solutionizing temperature to 450 to 550° C.

In addition, from the standpoint of suppressing the formation of coarse grain boundary precipitates which lower strength and formability, it is desirable to set the average cooling rate of the quenching after the solutionizing process to 5° C./s or higher. When this cooling rate is low, the coarse grain boundary precipitates are generated during cooling, and the amounts of solid-solutionized elements after the solutionizing process are lowered, whereby the amount of hardening during the painting baking process and preliminary aging treatment is lowered. To ensure this cooling rate, air cooling such as fans, water cooling means such as mist, spray, and immersing and conditions are respectively selected for use in the quenching.

In addition, from the standpoint of suppressing the formation of coarse grain boundary precipitates which lower strength and formability, it is desirable to set the average cooling rate of the quenching after the solutionizing process to 5° C./s or higher. When this cooling rate is low, the coarse grain boundary precipitates are generated during cooling, and the amounts of solid-solutionized elements after the solutionizing process are lowered, whereby the amount of solid solution hardened in the aging treatment that follows is lowered. To ensure this cooling rate, air cooling such as fans, water cooling means such as mist, spray, immersing and other conditions are respectively selected for use in the quenching.

Artificial Age Hardening Treatment Process:

The conditions of the artificial age hardening treatment process of the material plate produced as mentioned above after being formed into an automobile material are, for example, selected to provide the strength and elongation required as an automobile material. For example, in the case of a single-stage aging, the aging treatment at 100 to 150° C. is performed for 12 to 36 hours (including over-aging region). In addition, in a two-stage step, the heat treatment temperature of the first stage is selected from the range from 70 to 100° C. and the range of 2 hours or more, and the heat treatment temperature of the second stage is selected from the range from 100 to 170° C. and the range of 5 hours or more (including over-aging region).

### Examples

The 7000 series aluminum alloy cold-rolled plates of the compositions of constituents shown in Tables 1 and 3 below were produced. It was simulated that these thermally refined cold-rolled plate were applied to especially high-strength automobile structural materials of automobile parts, and the microstructures of these plates after the age hardening treatment and their mechanical characteristics were measured and evaluated. The results are shown in Table 2 below.

More specifically, in all Examples, molten metals of the 7000 series aluminum alloy of the compositions of constituents shown in Tables 1 and 3 below were cast by the DC casting, obtaining ingots each sizing 45 mm in thickness x 220 mm in width×145 mm in length. These ingots were subjected to a homogenizing heat treatment at 470° C.×4 hours, and then hot-rolled, producing hot-rolled plates having a gauge of 5.0 mm. These hot-rolled plates were cold-rolled without subjecting to rough annealing (annealing), or without subjecting to an intermediate annealing between passes, giving cold-rolled plates with a gauge of 2.0 mm in all cases. Moreover, these cold-rolled plates were water-cooled after the solutionizing process at 500° C.×30 seconds in all Examples. Finally, artificial age hardening treatment was performed simulating automobile structural materials under the conditions shown in Table 2 and 4 respectively.

Specimens were collected from the thus-obtained aluminum alloy cold-rolled plates and the aluminum alloy plates after the artificial age hardening treatment, and the number density and mechanical characteristics of fine precipitates within crystal grains in the aluminum alloy plates were examined in the manner described below. The results are shown in Table 2.

In addition, specimens were collected from the thus-obtained aluminum alloy plates after the artificial age hardening treatment, and the number density and mechanical characteristics of the above-mentioned fine precipitates within crystal grains were examined in the manner described below. The results are shown in Table 4.

(Mechanical Characteristics)

In each Example, plate-like specimens collected by cutting out central portions of the obtained aluminum alloy plates were subjected to room-temperature tensile tests in the direction perpendicular to the direction of rolling to measure their tensile strength (MPa), 0.2% proof stress (MPa), and total elongation (%). The room-temperature tensile tests were performed at room temperature, i.e., 20° C., according to JIS 2241(1980). The rate of pulling was 5 mm/min., and was performed at a constant rate until the specimens were ruptured.

(X-Ray Small-Angle Scattering Measurement)

The X-ray small-angle scattering measurement was performed using a horizontal X-ray diffractometer Smart Lab manufactured by Rigaku Corporation commonly in all Examples with an X-ray at a wavelength 1.54 Å, and the above-mentioned intensity profile of the X-ray scattering was measured in all Examples. The test apparatus causes an X-ray to be incident vertically to the surface of the specimen, and measures the X-ray scattered backward from the specimen at a fine angle (small angle) of 0.1 to 10 degrees relative to the incident X-ray using a detector. The measurement samples were thinly sliced into pieces each measuring about 80 μm and were measured.

This intensity profile of the X-ray scattering were fitted by the nonlinear least square method so that the values of the X-ray scattering intensities measured using an analysis software containing the above-mentioned known analysis method by Schmidt et al. incorporated therein, Grain Diameter Vacancy Analysis Software NANO-Solver [Ver. 3.5] manufactured by Rigaku Corporation, and the values the X-ray scattering intensities calculated by the analysis software were approximated, whereby average grain diameter and normalized dispersion were determined.

The average grain diameter was determined by calculating the scattering intensity using a theoretical equation on the assumption that the grain is a complete sphere, and fitting the calculated value with the experimental value. In addition, the normalized dispersion was used so that the extent of the grain distribution can be compared regardless of the grain size.

The equation of this normalized dispersion is shown below.

$${σ}_{n - 1}^{2} = \frac{Dispersion}{Average} = \frac{[ ( \frac{1}{n - 1} ) {\sum }_{i = 1}^{n} {( {x}_{i} - 〈 x 〉 )}^{2} ]}{\frac{1}{n} {\sum }_{i = 1}^{n} {x}_{i}} \qquad [ Equation 1 ]$$

Herein, σ is the normalized dispersion, n is the number of grains, x is the grain size, and <x> is the arithmetic mean of the grain size.

(Fine Precipitate)

In addition, in any of Examples shown in Table 3, thin film samples were prepared from the cross sections in central portions of the plate-like specimens, and portions with a film thickness of 0.1 μm were observed under a transmission electron microscope of 300000 magnifications at an accelerating voltage of 200 kV, and the average number density (counts/μm³) of precipitates sizing 2.0 to 20 nm within crystal grains was measured. This observation was performed on five specimens, and the number density of precipitates sizing 2.0 to 20 nm within crystal grains was determined respectively and averaged (average number density). Herein, the diameter of precipitates was, as mentioned above, measured as the diameters of circles having equivalent areas.

SCC Resistance:

Stress corrosion crack resistance tests were performed by the chromic acid promoting method to evaluate the SCC resistance of the aluminum alloy plate after the artificial age hardening treatment. Plate-like specimens were cut out from the thermally refined cold-rolled plate, and a load of a 4% strain was applied perpendicularly to the direction of rolling after the heat treatment at 400° C. After the age hardening treatments shown in Table 2 and 4, respectively, were performed, the specimens were immersed in a test solution at 90° C. for 10 hours at maximum, and the SCC was visually observed. It should be noted that the stress load was measured by generating a tensile stress on the outer surface of the specimen by tightening the bolt and nut of a jig, while the load strain was measured by a strain gauge adhered onto this outer surface. In addition, the test solution was prepared by adding 36 g of chromium oxide, 30 g of potassium dichromate, and 3 g of sodium chloride in (per liter of) distilled water. The samples on which no SCC was generated were evaluated as ∘, while those on which SCC was generated in up to 10 hours were evaluated as x.

As can be clearly seen from Tables 1 and 2, the invention examples in Table 1 fall within the range of the composition of the aluminum alloy of the present invention, and have, as the microstructures after being subjected to the painting and baking processes of the automobile body, the average grain diameters of the grain size distribution of precipitates within crystal grains measured by the small angle X-ray scattering of 1 nm or more but 7 nm or less, and have microstructures in which the normalized dispersion indicating the extent of the grain size distribution is 40% or lower. As a result, they each have the 0.2% proof stress after the artificial aging treatment of 350 MPa or higher, and preferably 400 MPa or higher, and has excellent SCC resistance. In addition, they each have the total elongation of 13.0% or higher, which is desirable.

In contrast, Comparative Examples in Table 1 have alloy compositions falling outside the range of the present invention, as shown in Table 1. In Comparative Example 6, the amount of Zn falls outside the lower limit. In Comparative Example 7, the amount of Mg falls outside the lower limit. These Comparative Examples are produced by preferable production methods, but their average grain diameters of the grain size distribution of precipitates within crystal grains measured by the small angle X-ray scattering are large, and their strengths are therefore low. Since Comparative Example 8 has the amount of Cu higher than the upper limit, a large crack was generated during the hot rolling and the production was stopped. Comparative Example 9 has the amount of Zr outside the upper limit. Accordingly, coarse precipitates were formed and elongation was significantly low.

In addition, Comparative Example 10 shows the case where it has alloy composition falling within the range of the present invention, as shown in Table 1, but its heating time of the artificial age hardening treatment is too short so that increased strength has not been achieved only by this painting and baking processes of the automobile body.

The results described above support the critical meanings of the requirements of the present invention for the aluminum alloy plate of the present invention to achieve higher strength, higher ductility and SCC resistance.

TABLE 1

| | | Aluminum alloy chemical constituent composition, mass % (remainder: Al) | | | | | | | | | |
|---|---|---|---|---|---|---|---|---|---|---|---|
| Section | Number | Zn | Mg | Cu | Ag | Zr | Mn | Cr | Si | Fe | Ti |
| Invention | 1 | 6.5 | 1.0 | — | — | — | — | — | 0.04 | 0.20 | — |
| Example | 2 | 5.9 | 1.2 | 0.30 | — | 0.15 | — | — | 0.04 | 0.15 | 0.03 |
| | 3 | 6.5 | 1.4 | 0.15 | — | 0.15 | — | 0.03 | 0.05 | 0.15 | 0.03 |
| | 4 | 7.5 | 0.7 | 0.15 | 0.05 | 0.25 | 0.05 | 0.10 | 0.30 | 0.15 | 0.10 |
| | 5 | 5.3 | 1.7 | — | 0.10 | — | 0.15 | 0.05 | 0.20 | 0.40 | 0.03 |
| Comparative | 6 | 2.4 | 1.2 | 0.15 | — | 0.15 | — | 0.04 | 0.04 | 0.20 | 0.03 |
| Example | 7 | 6.5 | 0.4 | — | 0.05 | 0.15 | 0.03 | — | 0.04 | 0.15 | 0.03 |
| | 8 | 6.5 | 0.8 | 2.0 | — | — | — | 0.04 | 0.12 | 0.15 | 0.03 |
| | 9 | 6.5 | 0.9 | 0.15 | — | 0.5 | — | 0.04 | 0.12 | 0.15 | 0.03 |
| | 10 | 6.5 | 1.2 | — | — | — | — | — | 0.04 | 0.20 | — |

TABLE 2

| | | | Microstructure and characteristics of automobile | | | | | | |
|---|---|---|---|---|---|---|---|---|---|
| | | | structural part after age hardening process | | | | | | |
| | | | Grain size distribution | | | | | | |
| | | | of precipitates | | Mechanical characteristics | | | | |
| | | | Mean grain | Normalized | Tensile | 0.2% | | | |
| | | Age hardening | diameter | dispersion | strength | proof stress | Elonga- | SCC | Overall |
| Section | Number | process conditions | nm | % | MPa | MPa | tion % | resistance | evaluation |
| Invention | 1 | 90° C. × 3 h → 140° C. × 8 h | 5.0 | 33.8 | 390 | 353 | 16.2 | ∘ | ∘ |
| Example | | → 170° C. × 20 min | | | | | | | |
| | 2 | 90° C. × 3 h → 140° C. × 8 h | 4.2 | 36.5 | 438 | 410 | 15.4 | ∘ | ∘ |
| | | → 170° C. × 20 min | | | | | | | |
| | 3 | 80° C. × 8 h → 160° C. × 5 h | 5.7 | 32.1 | 481 | 453 | 14.6 | ∘ | ∘ |
| | | → 170° C. × 20 min | | | | | | | |
| | 4 | 110° C. × 30 h → 170° C. × 20 min | 6.8 | 22.4 | 401 | 372 | 16.0 | ∘ | ∘ |
| | 5 | 120° C. × 24 h → 170° C. × 20 min | 4.7 | 28.9 | 455 | 428 | 15.1 | ∘ | ∘ |
| Comparative | 6 | 90° C. × 3 h → 140° C. × 8 h | 7.5 | 37.5 | 350 | 321 | 18.4 | ∘ | x |
| Example | | → 170° C. × 20 min | | | | | | | |
| | 7 | 90° C. × 3 h → 140° C. × 8 h | 8.4 | 38.1 | 368 | 340 | 17.2 | ∘ | x |
| | | → 170° C. × 20 min | | | | | | | |
| | 8 | | | | | | | | x |
| | 9 | 90° C. × 3 h → 140° C. × 8 h | 5.8 | 30.7 | 411 | 380 | 12.4 | ∘ | x |
| | | → 170° C. × 20 min | | | | | | | |
| | 10 | 170° C. × 20 min | 2.1 | 47.3 | 356 | 259 | 21.1 | ∘ | x |

In addition, as can be seen from Tables 3 and 4, the invention examples in Table 3 fall within the range of the composition of the aluminum alloy of the present invention, and have microstructures, as the microstructures after being subjected to the artificial age hardening treatment, the number density of precipitates with a diameter of 2.0 to 20 nm of 2.0×10⁴ counts/μm³ or higher in average. As a result, they each have the 0.2% proof stress after the artificial aging treatment of 350 MPa or higher, and preferably 400 MPa or higher, and has excellent SCC resistance. In addition, they each also have the total elongation of 13.0% or higher, which is desirable.

In contrast, Comparative Examples in Table 3 have alloy compositions falling outside the range of the present invention, as shown in Table 3. In Comparative Example 16, the amount of Zn is outside the lower limit. In Comparative Example 17, the amount of Mg is outside the lower limit. These Comparative Examples are produced by preferable production methods, but their number densities of precipitates with a diameter of 2.0 to 20 nm are low, so that their strengths are low. Since Comparative Example 18 has the amount of Cu falling outside the upper limit, and a large crack was generated during the hot rolling and the production was stopped. In Comparative Example 19, the amount of Zr is outside the upper limit. Accordingly, coarse precipitates were formed and elongation was significantly low.

In addition, Comparative Example 20 shows the case where it has alloy compositions falling outside the range of the present invention, as shown in Table 3, but for the reason that its heating time of the artificial age hardening treatment is too short and for other reasons, higher strength is not achieved.

The results described above support the critical meanings of the requirements of the present invention for the aluminum alloy plate of the present invention to achieve higher strength and higher ductility and SCC resistance.

TABLE 3

| | | Aluminum alloy chemical constituent composition, mass % (remainder: Al) | | | | | | | | | |
|---|---|---|---|---|---|---|---|---|---|---|---|
| Section | Number | Zn | Mg | Cu | Ag | Zr | Mn | Cr | Si | Fe | Ti |
| Invention | 11 | 6.5 | 1.0 | — | — | — | — | — | 0.04 | 0.20 | — |
| Example | 12 | 5.9 | 1.2 | 0.30 | — | 0.15 | — | — | 0.04 | 0.15 | 0.03 |
| | 13 | 6.5 | 1.4 | 0.15 | — | 0.15 | — | 0.03 | 0.05 | 0.15 | 0.03 |
| | 14 | 7.5 | 0.7 | 0.15 | 0.05 | 0.25 | 0.05 | 0.10 | 0.30 | 0.15 | 0.10 |
| | 15 | 5.3 | 1.7 | — | 0.10 | — | 0.15 | 0.05 | 0.20 | 0.40 | 0.03 |
| Comparative | 16 | 2.4 | 2.2 | 0.15 | — | 0.15 | — | 0.04 | 0.04 | 0.20 | 0.03 |
| Example | 17 | 6.5 | 0.4 | — | 0.05 | 0.15 | 0.03 | — | 0.04 | 0.15 | 0.03 |
| | 18 | 6.5 | 0.8 | 2.0 | — | — | — | 0.04 | 0.12 | 0.15 | 0.03 |
| | 19 | 6.5 | 0.9 | 0.15 | — | 0.5 | — | 0.04 | 0.12 | 0.15 | 0.03 |
| | 20 | 6.5 | 1.2 | — | — | — | — | — | 0.04 | 0.20 | — |

TABLE 4

| | | | Microstructure and characteristics of automobile | | | | | |
|---|---|---|---|---|---|---|---|---|
| | | | structural part after age hardening process | | | | | |
| | | | Precipitates sized | Mechanical characteristics | | | | |
| | | | 2.0 to 20 nm | Tensile | 0.2% | | | |
| | | Age hardening | Average number density × 10⁴ | strength | proof stress | Elonga- | SCC | Overall |
| Section | Number | process conditions | counts/μm³ | MPa | MPa | tion % | resistance | evaluation |
| Invention | 11 | 120° C. × 24 h | 2.2 | 383 | 351 | 16.8 | ∘ | ∘ |
| Example | 12 | 120° C. × 24 h | 6.2 | 445 | 411 | 15.2 | ∘ | ∘ |
| | 13 | 120° C. × 24 h | 8.9 | 487 | 468 | 14.5 | ∘ | ∘ |
| | 14 | 140° C. × 12 h | 3.0 | 390 | 360 | 16.5 | ∘ | ∘ |
| | 15 | 90° C. × 4 h → 150° C. × 5 h | 7.3 | 466 | 435 | 14.9 | ∘ | ∘ |
| Comparative | 16 | 120° C. × 24 h | 1.3 | 368 | 335 | 17.7 | ∘ | x |
| Example | 17 | 90° C. × 4 h → 150° C. × 5 h | 1.8 | 370 | 340 | 17.4 | ∘ | x |
| | 18 | | | | | | | x |
| | 19 | 120° C. × 24 h | 4.2 | 409 | 378 | 12.5 | ∘ | x |
| | 20 | 170° C. × 20 min | 0.3 | 356 | 259 | 21.1 | ∘ | x |

### INDUSTRIAL APPLICABILITY

As described above, the present invention can provide an automobile part having both strength and stress corrosion crack resistance made of a 7000 series aluminum alloy sheet. Therefore, it is suitable for automobile parts where aluminum alloy is used for the purpose of reducing the weight of the vehicle body, especially high-strength automobile structural components such as frames and pillars.

1. An aluminum alloy automobile part, in which an Al—Zn—Mg alloy sheet has the composition: containing, by mass %, Zn: 3.0 to 8.0%, and Mg: 0.5 to 4.0%, with the remainder consisting of Al and inevitable impurities, the aluminum alloy having, after the artificial age hardening treatment, an average′ grain diameter of the precipitates measured by the small angle X-ray scattering of 1 nm or more but 7 nm or less, having the normalized dispersion of the precipitate size distribution being 40% or lower, and having a 0.2% proof stress of 350 MPa or higher.

2. The automobile part according to claim 1, wherein the aluminum alloy further comprises, by mass %, one or two elements from Cu: 0.05 to 0.6%, and Ag: 0.01 to 0.15%.

3. The automobile part according to claim 1, wherein the aluminum alloy further comprises, by mass %, one or more elements from Mn: 0.05 to 0.3%, Cr: 0.03 to 0.2%, and Zr: 0.03 to 0.3%.

4. An aluminum alloy automobile part, in which an Al—Zn—Mg alloy sheet has the composition: containing, by mass %, Zn: 3.0 to 8.0%, and Mg: 0.5 to 4.0%, with the remainder consisting of Al and inevitable impurities, the aluminum alloy having, after the artificial age hardening treatment, a number density of precipitates with a diameter of 2.0 to 20 nm in the measurement under a transmission electron microscope of 300000 magnifications of 2.0×10⁴ counts/μm³ or higher in average, and having a 0.2% proof stress of 350 MPa or higher.

5. The automobile part according to claim 4, wherein the aluminum alloy further comprises, by mass %, one or two elements from Cu: 0.05 to 0.6%, and Ag: 0.01 to 0.15%.

6. The automobile part according to claim 4, wherein the aluminum alloy further comprises, by mass %, one or more elements from Mn: 0.05 to 0.3%, Cr: 0.03 to 0.2%, and Zr: 0.03 to 0.3%.
